(19) United States
(12) Patent Application Publication
(10) Pub. No.: US 2007/0045164 A1
(43) Pub. Date: Mar. 1, 2007

(54) Device for magnetizing water through winding path

(76) Inventor: Hui-Yu Liu, Taiping City (TW)

Correspondence Address: PRO-TECHTOR INTERNATIONAL SERVICES, 20775 NORADA CT., SARATOGA, CA, 95070, US

(21) Appl. No.: 11/218,079

(22) Filed: Aug. 31, 2005

(51) Int. Cl. C02F 1/48

(52) U.S. Cl. 210/222; 210/223

(57) ABSTRACT

A water magnetizing mechanism provided in a cylinder comprising an upper mounting assembly including an inlet and a first channel; a lower mounting assembly including an outlet and a second channel; tubes each, interconnected the first and second channels; and a magnetic assembly including magnetic rings put on the tubes, each magnetic ring having two opposite magnetic poles such that a magnetic field having a direction from one magnetic pole to the other magnetic pole is generated, non-magnetic members each sandwiched between the magnetic rings, and magnetic field absorbing plates each disposed longitudinally between the tubes for absorbing the magnetic field. Water flowing from the inlet is adapted to flow through the first channel, the tubes, and the second channel repeatedly until all of the tubes are traversed so as to be magnetized prior to exiting through the outlet.

### BACKGROUND OF THE INVENTION

1. Field of Invention

The present invention relates to devices for magnetizing water and more particularly to a device for magnetizing water through a plurality of internal winding path.

2. Related Art

Taiwanese Utility Model Patent No. 303,882 discloses a device for magnetizing water comprising a hollow cylinder, an inlet provided at one end of the cylinder, a pipe provided longitudinally in the cylinder, the pipe having a plurality of holes on its surface in fluid communication with a space between the cylinder and the pipe, an outlet provided at one end of the pipe, and a plurality of magnetic rings equally spaced apart along an axial direction of the pipe, each magnetic ring having two semi-circular magnetic poles. In operation, the magnetic poles are activated to magnetize water flowing through the pipe. However, water is only magnetized once and it is generally not sufficient. This is particularly true if water flow is quick. Further, water may be polluted due to oxidization of the magnetic rings as the magnetic rings are sunk in water. Thus, the need for improvement still exists.

### SUMMARY OF THE INVENTION

It is therefore an object of the present invention to provide a device for magnetizing water comprising a hollow cylinder including a bottom outlet and a cover having an inlet; and a water magnetizing mechanism provided in the cylinder and including an upper mounting assembly including a top intake releasably secured to the inlet and being in fluid communication therewith, and a first channel; a lower mounting assembly including an outlet pipe extended downward to connect to the outlet and being in fluid communication therewith, and a second channel; a plurality of tubes each interconnected the first channel and the second channel; and a magnetic assembly including a plurality of magnetic rings put on the tubes, each magnetic ring having at least one pair of opposite magnetic poles such that a magnetic field having a direction from one magnetic pole to the other magnetic pole of the same pair is adapted to generate, a plurality of non-magnetic members each sandwiched between an upper one of the magnetic rings and a lower one of the magnetic rings, and a plurality of magnetic field absorbing plates each disposed longitudinally between two adjacent ones of the tubes for absorbing the magnetic field generated by the magnetic rings; wherein water flowing into the intake through the inlet is adapted to flow through the first channel, the tubes, and the second channel repeatedly until all of the tubes are traversed so as to be magnetized prior to exiting through the outlet pipe.

In one aspect of the present invention, the number of the pair of the magnetic poles is one.

In another aspect of the present invention, the number of the tubes is three.

The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of device for magnetizing water according to the invention;

FIG. 2 is an exploded perspective view of the device shown in FIG. 1;

FIG. 3 is a longitudinal sectional view of the device shown in FIG. 1;

FIG. 4 is an exploded view of the water magnetizing mechanism shown in FIG. 2;

FIG. 5 is a top view of the water magnetizing mechanism shown in FIG. 2;

FIG. 6 is a sectional view taken along line A-A of FIG. 5;

FIG. 7 is a side view of the water magnetizing mechanism shown in FIG. 2;

FIG. 8 is a sectional view taken along line B-B of FIG. 7;

FIG. 9 is an exploded perspective view of the water magnetizing mechanism shown in FIG. 2 showing water flowing therethrough in a magnetizing operation;

FIG. 10 is a top view of the magnetic ring shown in FIG. 9; and

FIG. 11 is a longitudinal sectional view of the stacked magnetic rings shown in FIG. 9.

### DETAILED DESCRIPTION OF THE INVENTION

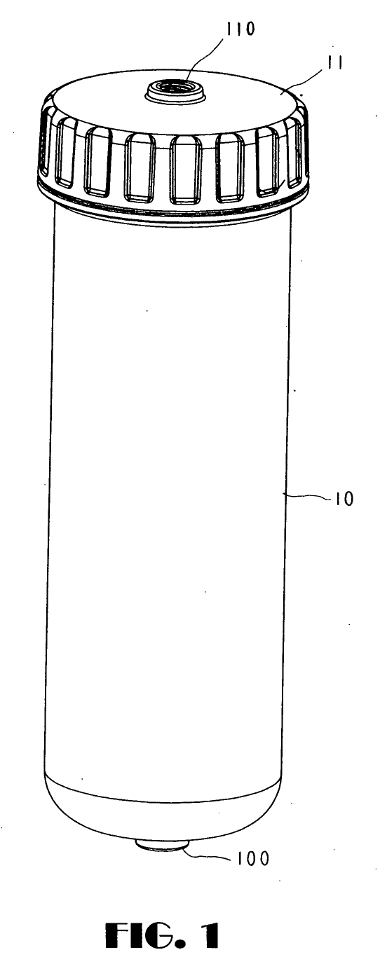

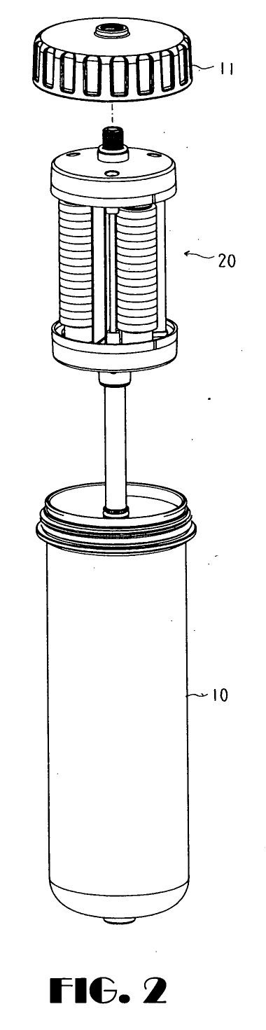

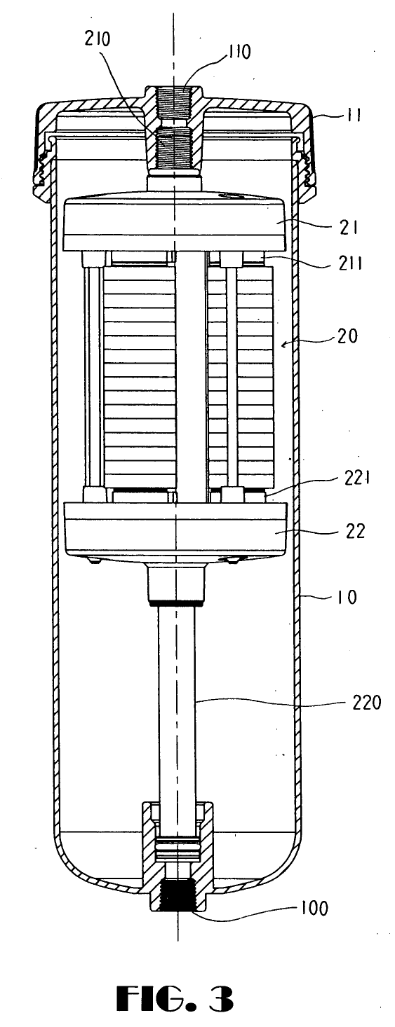

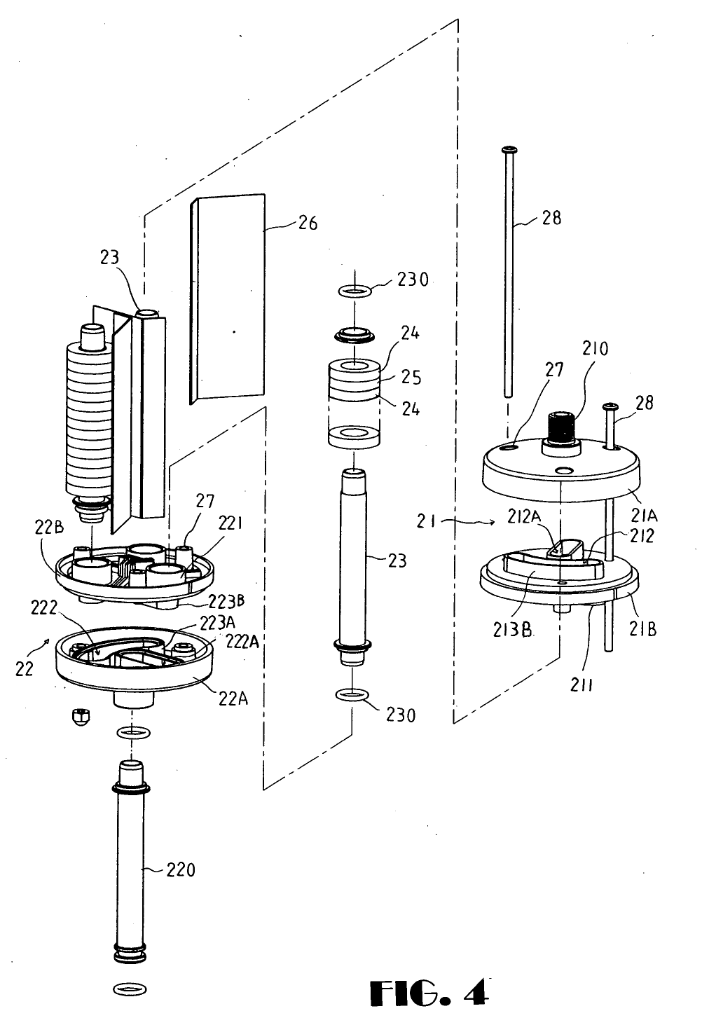

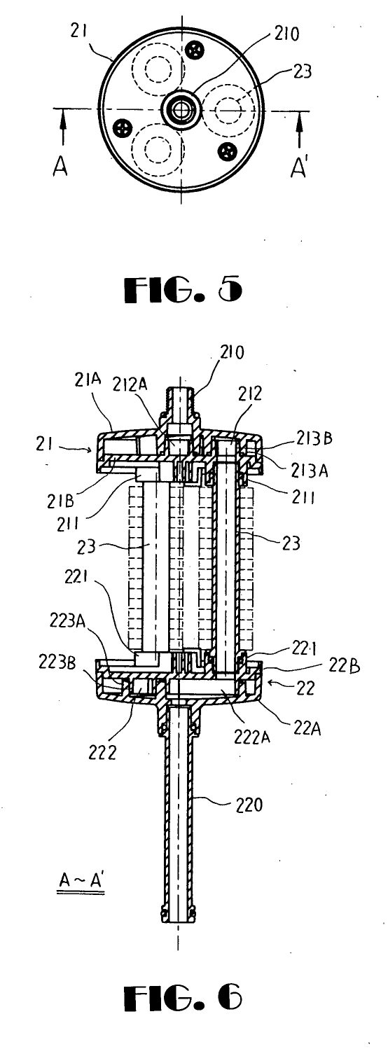

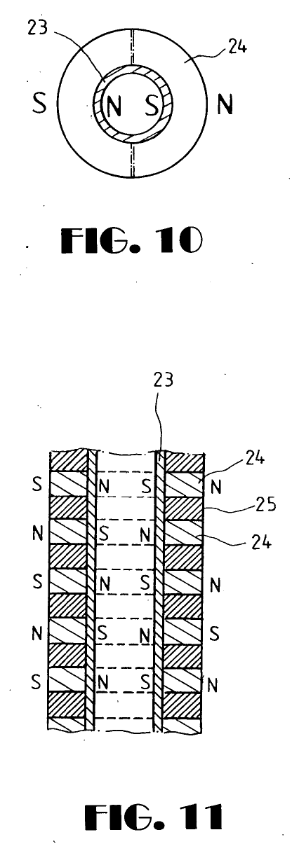

Referring to FIGS. 1 to 11, a device for magnetizing water in accordance with a preferred embodiment of the invention comprises a hollow cylinder 10 including a bottom outlet 100, a cover 11 threadedly secured to a top of the cylinder 10, the cover 11 having a central inlet 110, and a water magnetizing mechanism 2 provided inside the cylinder 10 and comprising an upper mounting assembly 21, a lower mounting assembly 22, a plurality of tubes (three are shown) 23 interconnected the upper mounting assembly 21 and the lower mounting assembly 22, and a plurality of stacked magnetic rings 24 put on the tubes 23. Each component is discussed in detailed below.

The upper mounting assembly 21 comprises an extending top intake 210 having outer threads threadedly secured to the inlet 110 and being in fluid communication therewith, a plurality of connectors 211 on a bottom each secured to a top end of the tube 23 and being in fluid communication therewith, a first channel 212, and a second channel 212A.

The lower mounting assembly 22 comprises an outlet pipe 220 extended downward to secure to the outlet 100 and being in fluid communication therewith, a plurality of connectors 221 on a top each secured to a bottom end of the tube 23 and being in fluid communication therewith, a third channel 222, and a fourth channel 222A.

The tube 23 comprises two seals 230 on both top and bottom and being secured to the connectors 211 and the 221 respectively. Also, the first tube 23 is interconnected the second channel 212A and the third channel 222, the second tube 23 is interconnected the third channel 222 and the first channel 212, and the third tube 23 is interconnected the first channel 212 and the fourth channel 222A. A plurality of non-magnetic members 25 each is sandwiched between an upper magnetic ring 24 and a lower magnetic ring 24. That is, there is a predetermined distance between two adjacent magnetic rings 24. Thus, the tube 23 can be magnetized when the magnetic rings 24 are activated.

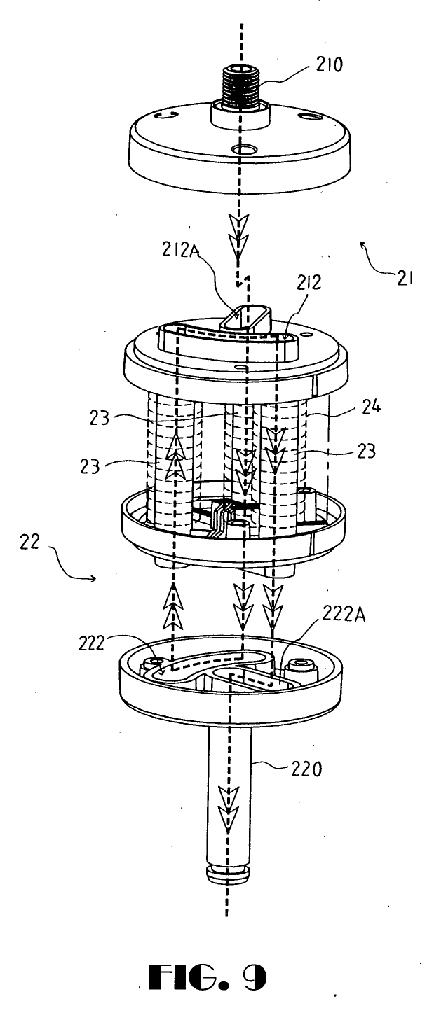

In operation (see FIG. 9), water flows into the intake 210 through the inlet 110. Next, water flows through the second channel 212A, the first tube 23, the third channel 222, the second tube 23, the first channel 212, the third tube 23, and the fourth channel 222A sequentially. Water in each tube 23 is magnetized by the magnetic rings 24 therearound (i.e., water is magnetized through winding path). Thus, water is magnetized sufficiently after entering the outlet pipe 220. Also, water is not in contact with the magnetic rings 24. As a result, water pollution is avoided.

Each magnetic ring 24 has two opposite magnetic poles (e.g., north magnetic pole (N) and south magnetic pole (S)). Thus, a strong magnetic field is generated having a direction from N pole to S pole and the magnetic field is adapted to magnetize water flowing through the tubes 23.

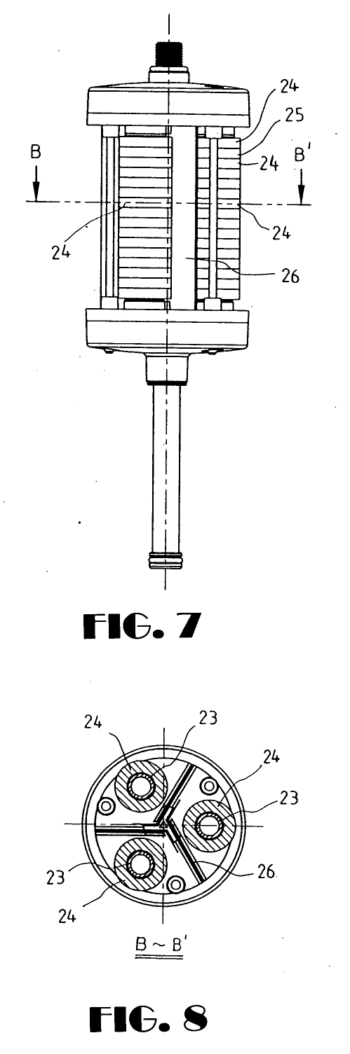

As shown in FIGS. 7 and 8, three magnetic field absorbing plates 26 are provided each disposed longitudinally between two tubes 23. Also, the magnetic field absorbing plate 26 has a height substantially the same as that of the tube 23. Thus, magnetic field generated by the magnetic rings 24 around one tube 23 is not interfered by magnetic field generated by the magnetic rings 24 around another tube 23.

The upper mounting assembly 21 comprises an upper seat 21A having the intake 210, and a lower seat 21B having three connectors 211. The upper seat 21A comprises a closed frame element 213A on its bottom and the lower seat 21B comprises a closed frame element 213B on its top. The seats 21A and 21B are adapted to matingly engage with the first channel 212 being formed in the frame element 213B and in fluid communication with the tube 23 through the connector 211, and the second channel 212A being formed by the frame elements 213A and in fluid communication with the tube 23 through the connector 211, and the intake 210 respectively. Similarly, the lower mounting assembly 22 comprises a lower seat 22A having the outlet pipe 220, and an upper seat 22B having three connectors 221. The lower seat 22A comprises a closed frame element 223A on its top and the upper seat 22B comprises a closed frame element 223B on its bottom. The seats 22A and 22B are adapted to matingly engage with the third channel 222 being formed in the frame element 223A and in fluid communication with the tube 23 through the connector 221, and the fourth channel 222A being formed by the frame elements 223B and in fluid communication with the tube 23 through the connector 221, and the outlet pipe 220 respectively.

In assembly, drive three fasteners 28 through three threaded holes 27 of the upper mounting assembly 21 into three threaded holes 27 of the lower mounting assembly 22 for fastening the upper mounting assembly 21 and the lower mounting assembly 22 together with the tubes 23 mounted therebetween (i.e., a complete water magnetizing mechanism 20 is formed).

While the invention herein disclosed has been described by means of specific embodiments, numerous modifications and variations could be made thereto by those skilled in the art without departing from the scope and spirit of the invention set forth in the claims.

What is claimed is:

1. A device for magnetizing water comprising:
a hollow cylinder including a bottom outlet and a cover having an inlet; and
a water magnetizing mechanism disposed in the cylinder and including:
an upper mounting assembly including a top intake releasably secured to the inlet and being in fluid communication therewith, and a first channel;
a lower mounting assembly including an outlet pipe extended downward to connect to the outlet and being in fluid communication therewith, and a second channel;
a plurality of tubes each interconnected the first channel and the second channel; and
a magnetic assembly including a plurality of magnetic rings put on the tubes, each magnetic ring having at least one pair of opposite magnetic poles such that a magnetic field having a direction from one magnetic pole to the other magnetic pole of the same pair is adapted to generate, a plurality of non-magnetic members each sandwiched between an upper one of the magnetic rings and a lower one of the magnetic rings, and a plurality of magnetic field absorbing plates each disposed longitudinally between two adjacent ones of the tubes for absorbing the magnetic field generated by the magnetic rings;
wherein water flowing into the intake through the inlet is adapted to flow through the first channel, the tubes, and the second channel repeatedly until all of the tubes are traversed so as to be magnetized prior to exiting through the outlet pipe.

2. The device of claim 1, wherein the number of the pair of the magnetic poles is one.

3. The device of claim 1, wherein the number of the tubes is three.
